(19) United States
(12) Patent Application Publication
(10) Pub. No.: US 2009/0180943 A1
(43) Pub. Date: Jul. 16, 2009

(54) Selective Ammonia Oxidation Catalysts

(75) Inventor: Matthew Tyler Caudle, Hamilton, NJ (US)

Correspondence Address: BASF CATALYSTS LLC, 100 CAMPUS DRIVE, FLORHAM PARK, NJ, 07932, US

(73) Assignee: BASF Catalysts LLC, Florham Park, NJ (US)

(21) Appl. No.: 12/354,297

(22) Filed: Jan. 15, 2009

Related U.S. Application Data
(63) Continuation-in-part of application No. 12/014,882, filed on Jan. 16, 2008.

(51) Int. Cl. B01D 53/94; B01J 23/42

(52) U.S. Cl. 423/213.5; 502/339

(57) ABSTRACT

Catalysts, methods and systems for treating diesel engine exhaust streams are described. In one or more embodiments, the catalyst comprises a refractory metal oxide, a transition metal oxide, and platinum, the catalyst being effective to oxidize ammonia at temperatures less than about 300° C. and exhibiting no significant decrease in ammonia oxidation efficiency upon hydrothermal aging. Methods and systems including such catalysts are also provided.

### CROSS REFERENCE TO RELATED APPLICATION

This application is a continuation-in-part of copending U.S. patent application Ser. No. 12/014,882, filed Jan. 16, 2008, which is hereby incorporated by reference in its entirety.

### TECHNICAL FIELD

Exhaust emissions treatment systems and catalysts for internal combustion engines and methods for their manufacture and use with lean burn engines, including diesel engines and lean burn gasoline engines, are disclosed.

### BACKGROUND

Diesel engine exhaust is a heterogeneous mixture which contains not only gaseous emissions such as carbon monoxide (“CO”), unburned or partially burned hydrocarbons or oxygenates thereof (“HC”) and nitrogen oxides (“NOₓ”), but also condensed phase materials (liquids and solids) which constitute the so-called particulates or particulate matter. Often, catalyst compositions and substrates on which the compositions are disposed are provided in diesel engine exhaust systems to convert certain or all of these exhaust components to innocuous components. For example, diesel exhaust systems can contain one or more of a diesel oxidation catalyst, a soot filter and a catalyst for the abatement of NOₓ.

A proven NOₓ abatement technology applied to stationary sources with lean exhaust conditions is Selective Catalytic Reduction (SCR). In this process, NOₓ is reduced with ammonia (NH₃) to nitrogen (N₂) over a catalyst typically composed of base metals. This technology is capable of NOₓ reduction greater than 90%, and thus it represents one of the best approaches for achieving aggressive NOₓ abatement goals. SCR provides efficient conversions of NOₓ as long as the exhaust temperature is within the active temperature range of the catalyst.

Reduction of NOₓ species to N₂ using NH₃ is of interest for meeting NOₓ emission targets in lean burn engines. A consequence of using NH₃ as a reductant is that under conditions of incomplete conversion or exhaust temperature upswings, NH₃ can slip from the exhaust of the vehicle. To avoid slippage of NH₃, a sub-stoichiometric quantity of NH₃ can be injected into the exhaust stream, but there will be decreased NOₓ conversion. Alternatively, the NH₃ can be overdosed into the system to increase NOₓ conversion rate, but the exhaust then needs to be further treated to remove excess or slipped NH₃. Even at a substoichiometric dosage of NH₃, an increase in exhaust temperature may release ammonia stored on the NOₓ abatement catalyst, giving an NH₃ slip. Conventional precious-metal based oxidation catalysts such as platinum supported on alumina can be very efficient at NH₃ removal above 225° C., but they produce considerable N₂O and NOₓ as undesired side products instead of the desired N₂ product. Thus, there is a need for a lower cost catalyst composition that is active for NH₃ oxidation at temperatures as low as 225° C., that has N₂ selectivity in excess of about 60% below 300° C., and after aging at 700° C. to 800° C.

### SUMMARY

Aspects of the invention pertain to catalysts, methods, and systems for treating exhaust gas. According to one or more embodiments of the invention, methods for treating emissions produced in the exhaust gas stream of a diesel vehicle are provided. A vehicle's engine exhaust stream is passed through a NOₓ abatement catalyst. The exhaust stream exiting the NOₓ abatement catalyst, which may contain ammonia, is passed through an oxidation catalyst. The oxidation catalyst comprises a refractory metal oxide, a transition metal oxide and platinum. The oxidation catalyst may be effective to oxidize ammonia at temperatures less than about 300° C. The oxidation catalyst exhibits no significant decrease in ammonia oxidation efficiency upon aging at temperatures in the range of about 700° C. to about 800° C. for up to 50 hrs in the presence of about 10% water vapor in air and a gas hourly space velocity (GHSV) of 4580/hr. According to one or more embodiments, the transition metal oxide comprises a CuₓO, or a chemical or physical mixture of CuₓO.

Other embodiments of the invention are directed to catalysts for oxidizing ammonia. The catalyst comprises a refractory metal oxide, a transition metal oxide, and platinum. The oxidation catalyst may be effective to oxidize ammonia at temperatures less than about 300° C. In one embodiment, the platinum is present in the range of about 0.05% and 2.0% by weight of the catalyst and the transition metal oxide is present in the range of about 0.5% and 15% weight percent of the catalyst. In one embodiment, the oxidation catalyst also exhibits no significant decrease in ammonia oxidation efficiency upon hydrothermal aging, for example, at temperatures in the range of about 700° C. to about 800° C. for up to 50 hrs in the presence of 10% water vapor in air and a gas hourly space velocity (GHSV) of 4580/hr. According to one or more embodiments, the transition metal oxide comprises a CuₓO, or a chemical or physical mixture of CuₓO.

Further embodiments of the invention are directed to treatment systems for an exhaust stream containing NOₓ. The treatment system comprises an upstream catalyst composition being effective for decreasing NOₓ; and a downstream oxidation catalyst composition being effective for oxidizing ammonia. The oxidation catalyst comprises a refractory metal oxide, a transition metal oxide, and platinum. In one embodiment, the platinum is present in the range of about 0.05% and 2.0% by weight of the catalyst and the transition metal oxide is present in the range of about 0.5% and 15% weight percent of the catalyst. The oxidation catalyst may be effective to oxidize ammonia at temperatures less than about 300° C. In one embodiment, the oxidation catalyst also exhibits no significant decrease in ammonia oxidation efficiency upon hydrothermal aging, for example, at temperatures in the range of about 700° C. to about 800° C. for up to 50 hrs in the presence of about 10% water vapor in air and a gas hourly space velocity (GHSV) of 4580/hr.

### BRIEF DESCRIPTION OF THE DRAWINGS

FIG. 1 shows a schematic depiction of an embodiment of an emission treatment system;

FIG. 2 shows a perspective view of a wall-flow filter substrate;

FIG. 3 shows a cross-sectional view of a section of a wall flow filter substrate;

FIG. 4 is a graph showing the effects of copper oxide content on the catalyst activity;

FIG. 5 is a graph showing the effects of platinum content on the catalyst activity;

FIG. 6 is an optimization matrix for a platinum and copper oxide on support system;

FIG. 7 is graph showing the effects of platinum content on the catalyst activity;

FIG. 8 is a graph showing the effects of copper oxide on N₂O and NOₓ emissions;

FIG. 9 shows a 200 keV transmission electron micrograph of 1.6% Pt+10% CuO on Siralox1.5 after preparative calcination at 550° C.; and

FIG. 10 shows hydrogen temperature programmed reduction profiles for 10% CuO on Siralox1.5 as a function of increasing Pt content.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

As used in this specification and the appended claims, the singular forms “a”, “an” and “the” include plural referents unless the context clearly indicates otherwise. Thus, for example, reference to “a catalyst” includes a mixture of two or more catalysts, and the like. As used herein, the term “abate” means to decrease in amount and “abatement” means a decrease in the amount, caused by any means. Where they appear herein, the terms “exhaust stream” and “engine exhaust stream” refer to the engine out effluent as well as to the effluent downstream of one or more other catalyst system components including but not limited to a diesel oxidation catalyst and/or soot filter.

According to one or more embodiments of the invention, methods for treating emissions produced in the exhaust gas stream of a diesel vehicle are provided. A vehicle's engine exhaust stream is passed through a NOₓ abatement catalyst. The exhaust stream exiting the NOₓ abatement catalyst, which may contain unreacted ammonia, is passed through an oxidation catalyst to be mainly converted to N₂. The oxidation catalyst comprises a refractory metal oxide, a transition metal oxide and platinum. The oxidation catalyst may be effective to oxidize ammonia at temperatures less than about 300° C. In one embodiment, the platinum is present in the range of about 0.05% and 2.0% by weight of the catalyst and the transition metal oxide is present in the range of about 0.5% and 15% weight percent of the catalyst. As used herein weight percent of the catalyst does include the weight of substrate upon which the catalyst is loaded. For example, in one embodiment, for a catalyst in the form of a washcoat on a honeycomb substrate, the weight percent of the components of the catalyst would not include the weight of the honeycomb substrate. In one or more embodiments, the oxidation catalyst does not exhibit a significant decrease in ammonia oxidation efficiency after hydrothermal aging. In one embodiment, the oxidation catalyst exhibits no significant decrease in ammonia oxidation efficiency upon hydrothermal aging, for example, at temperatures in the range of about 700° C. to about 800° C. for up to 50 hours in the presence of about 10% water vapor in air and a gas hourly space velocity (GHSV) of 4580/hr. In other embodiments, the oxidation catalyst may be effective to oxidize ammonia at temperatures less than about 275° C., 250° C. and/or 225° C.

In specific embodiments, the platinum is present in the range of about 0.05% and about 1.6%. In other specific embodiments, the platinum is present at least in an amount of about 0.1%, 0.2%, 0.3%, 0.4%, 0.5%, 1% or 1.5% by weight. In more detailed embodiments, the platinum is present at most in an amount of about 2.0%, 1.6%, 1.5%, 1.0%, 0.5% by weight. In further detailed embodiments, the platinum is present in the range of about 0.05% and about 1.0% by weight. In still further detailed embodiments, the platinum is present at about 0.2%, 1.0% or 1.6% by weight.

In detailed embodiments the transition metal oxide is present at least about 0.5%, 1.0%, 2.0%, 2.5%, 3.0%, 4.0%, 5.0%, 7.5% or 10% by weight. In other detailed embodiments, the transition metal oxide is present in an amount at most about 15%, 12%, 10%, 7.5% or 5% by weight. In additional specific embodiments, the transition metal oxide is present in the range of about 0.5% and about 10 weight percent. In further specific embodiments, the transition metal oxide is present at about 2.5% or 10% by weight.

According to one or more detailed aspects of the invention, the transition metal oxide is a copper oxide (CuₓO). The CuₓO of some aspects is present at about 2.5% by weight. In a very specific embodiments, the CuₓO is present at about 2.5% by weight and the platinum is present at about 0.2% by weight.

The transition metal oxide of some embodiments comprises a CuₓO, or a chemical or physical mixture of CuₓO, where X is between to 0 and 2. In some detailed embodiments, platinum is present in the catalyst in an amount between 0.05% and 0.5% by weight (not including the substrate), and CuₓO is present in the range of about 0.5% and about 5% by weight (not including substrate). In other detailed embodiments, the total oxidation catalyst loading on a substrate is in the range of about 0.2 g/in³ and about 2.0 g/in³.

The NOₓ abatement catalyst of one or more embodiments comprises a selective catalytic reduction (SCR) catalyst, a lean NOₓ trap (LNT) catalyst, or other catalyst for the destruction of NOₓ that results in a possible slippage of ammonia from the NOₓ abatement catalyst.

The NOₓ abatement catalyst and oxidation catalyst composition can be disposed as a washcoat on the same or separate substrates. If disposed on separate substrates, one of the substrates may be a wall-flow filter. When disposed on a single substrate, a wall-flow filter or flow-through filter substrate may be employed. Furthermore, the SCR catalyst and the selective ammonia oxidation catalyst may be in the same catalyst housing or may be in different catalyst housings.

Other aspects are directed to catalysts for oxidizing ammonia. The catalyst comprises a refractory metal oxide, a transition metal oxide, and platinum. In one embodiment, the platinum is present in the range of about 0.05% and 2.0% by weight of the catalyst and the transition metal oxide is present in the range of about 0.5% and 15% weight percent of the catalyst. The oxidation catalyst may be effective to oxidize ammonia at temperatures less than about 300° C. In one embodiment, the oxidation catalyst exhibits no significant decrease in ammonia oxidation efficiency upon hyrodthermal aging, for example, at temperatures in the range of about 700° C. to about 800° C. for up to 50 hrs in the presence of 10% water vapor in air and a gas hourly space velocity (GHSV) of 4580/hr.

Further embodiments are for treatment systems for an exhaust stream containing NOₓ. In one embodiment, the treatment system comprises an upstream catalyst composition being effective for decreasing NOₓ; and a downstream oxidation catalyst composition being effective for oxidizing ammonia. The oxidation catalyst comprises a refractory metal oxide, a transition metal oxide, and platinum. The oxidation catalyst may be effective to oxidize ammonia at temperatures less than about 300° C. In one embodiment, the platinum is present in the range of about 0.05% and 2.0% by weight of the catalyst and the transition metal oxide is present in the range of about 0.5% and 15 weight percent of the catalyst. In one embodiment, the oxidation catalyst exhibits no significant decrease in ammonia oxidation efficiency upon accelerated hydrothermal aging, for example, at temperatures in the range of about 700° C. to about 800° C. for up to 50 hours in the presence of about 10% water vapor in air and a gas hourly space velocity (GHSV) of 4580/hr.

The engine treatment system according to one or more embodiments includes a metering system for metering ammonia, or an ammonia precursor, or a mixture of different ammonia precursors continuously or at periodic intervals into the exhaust stream.

One embodiment of an inventive emission treatment system is schematically depicted in FIG. 1. As can be seen in FIG. 1, the exhaust containing gaseous pollutants (including unburned hydrocarbons, carbon monoxide and NOₓ) and particulate matter is conveyed to an SCR catalyst 16 as described above, according to one or more embodiments. Ammonia gas 12 may be metered into the exhaust stream through metering device 14. After a mixing distance before it enters the SCR catalyst, the radial ammonia concentration perpendicular to the exhaust gas flow may be or may not be uniform. In the SCR catalyst 16, NOₓ is converted, with the help of NH₃, to N₂ and H₂O. Residual NH₃ slips from the SCR catalyst 16 to an NH₃ Oxidation Catalyst 16 downstream. In the NH₃ Oxidation Catalyst, the residual NH₃ is converted to N₂ and H₂O.

### The Substrate

According to one or more embodiments, the substrate may be any of those materials typically used for preparing automotive catalysts and will typically comprise a metal or ceramic honeycomb structure. Any suitable substrate may be employed, such as a monolithic flow-through substrate of the type having a plurality of fine, parallel gas flow passages extending from an inlet to an outlet face of the substrate, such that passages are open to fluid flow. The passages, which are essentially straight paths from their fluid inlet to their fluid outlet, are defined by walls on which the catalytic material is coated as a “washcoat” so that the gases flowing through the passages contact the catalytic material. The flow passages of the monolithic substrate are thin-walled channels which can be of any suitable cross-sectional shape such as trapezoidal, rectangular, square, sinusoidal, hexagonal, oval, circular, etc. Such structures may contain from about 60 to about 1200 or more gas inlet openings (i.e., “cells”) per square inch of cross section (cpsi). A representative commercially-available flow-through substrate is the Coming 400/6 cordierite material, which is constructed from cordierite and has 400 cpsi and wall thickness of 6 mil. However, it will be understood that the invention is not limited to a particular substrate type, material, or geometry.

The ceramic substrate may be made of any suitable refractory material, e.g., cordierite, cordierite-α alumina, silicon nitride, zircon mullite, spodumene, alumina-silica magnesia, zircon silicate, sillimanite, magnesium silicates, zircon, petalite, α alumina, aluminosilicates and the like.

The substrates useful for the layered catalyst composites of embodiments of the present invention may also be metallic in nature and be composed of one or more metals or metal alloys. Exemplary metallic supports include the heat resistant metals and metal alloys such as titanium and stainless steel as well as other alloys in which iron is a substantial or major component. Such alloys may contain one or more of nickel, chromium and/or aluminum, and the total amount of these metals may comprise at least 15 wt. % of the alloy, e.g., 10-25 wt. % of chromium, 3-8 wt. % of aluminum and up to 20 wt. % of nickel. The alloys may also contain small or trace amounts of one or more other metals such as manganese, copper, vanadium, titanium and the like. The metallic substrates may be employed in various shapes such as corrugated sheet or monolithic form. A representative commercially-available metal substrate is manufactured by Emitec. However, it will be understood that the invention is not limited to a particular substrate type, material, or geometry. The surface of the metal substrates may be oxidized at high temperatures, e.g., 1000° and higher, to form an oxide layer on the surface of the substrate, improving the corrosion resistance of the alloy. Such high temperature-induced oxidation may also enhance the adherence of the refractory metal oxide support and catalytically-promoting metal components to the substrate.

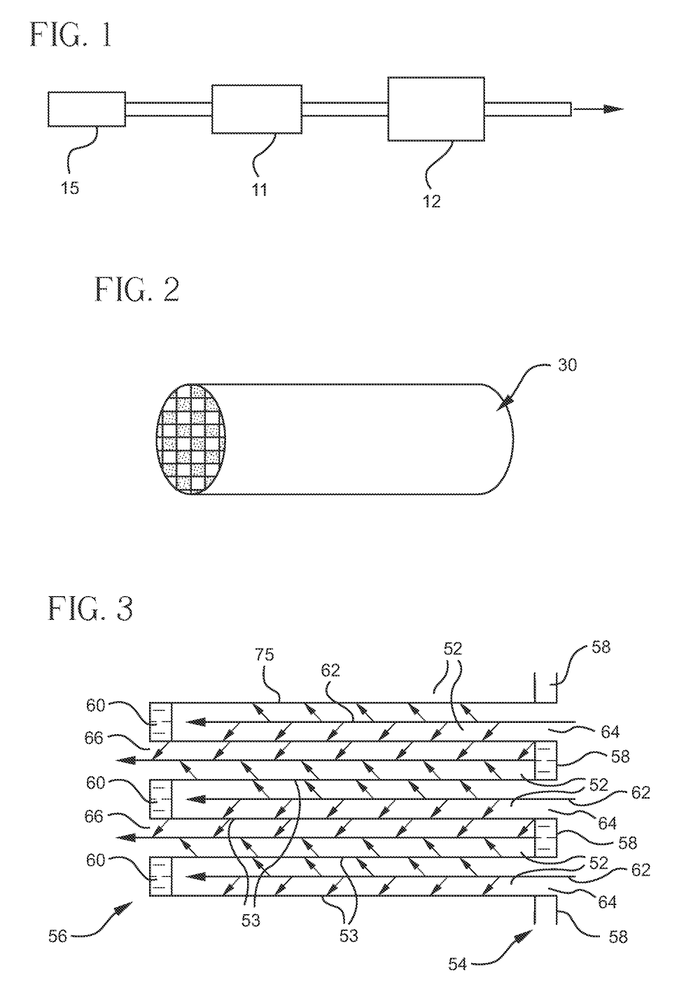

In alternative embodiments, the substrate may be a wall-flow substrate. FIGS. 2 and 3 depict a schematic of a wall flow filter substrate which has a plurality of passages extending along the longitudinal axis of the substrate. Typically, each passage is blocked at one end of the substrate body with a non-porous plug, with alternate passages blocked at opposite end-faces. This requires that gas flow through the porous walls of the wall-flow substrate to pass through the part. Such monolithic substrates may contain up to about 700 or more flow passages (or “cells”) per square inch of cross section, although far fewer may be used. For example, the substrate may have from about 7 to 600, more usually from about 100 to 400, cells per square inch (“cpsi”). The cells can have cross sections that are rectangular, square, circular, oval, triangular, hexagonal, or are of other polygonal shapes. Wall flow substrates typically have a wall thickness between 0.002 and 0.1 inches. Preferred wall flow substrates have a wall thickness of between 0.002 and 0.015 inches. A representative commercially available wall-flow substrate is the Corning CO substrate, which is constructed from a porous cordierite. However, it will be understood that the invention is not limited to a particular substrate type, material, or geometry.

### The Washcoat Layer(s)

According to one or more embodiments, the washcoat layer which is deposited upon, i.e., coated upon and adhered to, the substrate comprises platinum and copper deposited on a support. A suitable support is a high surface area refractory metal oxide. Examples of high surface refractory metal oxides include, but are not limited to, a high surface area refractory metal oxide such as alumina, silica, titania, ceria and zirconia and physical mixtures or chemical combinations thereof, including atomically doped combinations. The refractory metal oxide may consist of or contain a mixed oxide such as silica-alumina, aluminosilicates which may be amorphous or crystalline, alumina-zirconia, alumina-lanthana, alumina-baria-lanthania-neodymia, alumina-chromia, alumina-baria, alumina-ceria, and the like. An exemplary refractory metal oxide comprises gamma alumina having a specific surface area of about 50 to about 300 m²/g.

A suitable method of preparing the washcoat layer is to prepare a mixture or a solution of a platinum component in a suitable vehicle, e.g. water. Generally, from the point of view of economics and environmental aspects, aqueous solutions of soluble compounds or complexes of the platinum are preferred. Typically, the platinum component is utilized in the form of a compound or complex to achieve dispersion of the component on the refractory metal oxide support, e.g., gamma alumina. For the purposes of the present invention, the term “platinum component” means any compound, complex, or the like which, upon calcination or initial phase of use thereof, decomposes or otherwise converts to a catalytically active form, usually the platinum metal or the metal oxide. Suitable platinum complexes or compounds include, but are not limited to platinum chlorides (e.g. salts of [PtCl₄]²⁻, [PtCl₆]²⁻), platinum hydroxides (e.g. salts of [Pt(OH)₆]²⁻), platinum ammines (e.g. salts of [Pt(NH₃)₄]²⁺, ]Pt(NH₃)₄]⁴⁺), platinum hydrates (e.g. salts of [Pt(OH₂)₄]²⁺), and mixed compounds or complexes (e.g. [Pt(NH₃)₂(Cl)₂]). A representative commercially-available platinum source is 99% ammonium hexachloroplatinate from Strem Chemicals, Inc., which may contain traces of other precious metals. However, it will be understood that this invention is not restricted to platinum precursors of a particular type, composition, or purity. A mixture or solution of the platinum precursor is impregnated onto the high-surface area refractory metal oxide support, such as gamma alumina, which is sufficiently dry to absorb substantially all of the solution to form a wet solid. This wet solid can be chemically reduced or calcined or be used as is. Impregnation of the platinum compound may be followed by impregnation of a copper compound. This may be accomplished by preparing a mixture or a solution of a copper complex or compound in a suitable vehicle, e.g. water. Suitable copper complexes or compounds include, but are not limited to anhydrous and hydrated copper sulfate, copper nitrate, copper acetate, copper oxide, copper hydroxide, and salts of copper ammines (e.g. [Cu(NH₃)₄]²⁺). A representative commercially-available copper source is 97% copper acetate from Strem Chemicals, Inc., which may contain traces of other metals. However, it will be understood that this invention is not restricted to copper precursors of a particular type, composition, or purity. A mixture or solution of the copper precursor is impregnated onto the refractory metal oxide support which is sufficiently dry to absorb substantially all of the solution to form a wet solid. This mixture may be chemically reduced or calcined or be used as is.

To apply the catalyst layer to the substrate, finely divided particles of the catalyst, consisting of a high surface area refractory metal oxide onto which has been impregnated or supported a platinum component and a copper component, are suspended in an appropriate vehicle, e.g., water, to form a slurry. Alternatively, the platinum and/or copper precursors may be added directly to the slurry of high surface area refractory metal oxide. Other promoters and/or stabilizers and/or surfactants may be added to the slurry as mixtures or solutions in water or a water-miscible vehicle. In one or more embodiments, the slurry is comminuted to result in substantially all of the solids having particle sizes of less than about 10 microns, i.e., between about 0.1-8 microns, in an average diameter. The comminution may be accomplished in a ball mill, continuous Eiger mill, or other similar equipment. In one or more embodiments, the suspension or slurry has a pH of about 2 to less than about 7. The pH of the slurry may be adjusted if necessary by the addition of an adequate amount of an inorganic or an organic acid to the slurry. The solids content of the slurry may be, e.g., about 20-60 wt. %, and more particularly about 35-45 wt. %. The substrate may then be dipped into the slurry, or the slurry otherwise may be coated on the substrate, such that there will be deposited on the substrate a desired loading of the catalyst layer. Thereafter the coated substrate is dried at about 100° C. and calcined by heating, e.g., at 300-650° C. for about 1 to about 3 hours. Drying and calcination are done in air. The coating, drying, and calcination processes may be repeated if necessary to achieve the final desired loading of the catalyst on the support. In some cases, the complete removal of the liquid and other volatile components may not occur until the catalyst is placed into use and subjected to the high temperatures encountered during operation.

After calcining, the catalyst loading can determined be through calculation of the difference in coated and uncoated weights of the substrate. As will be apparent to those of skill in the art, the catalyst loading can be modified by altering the solids content of the coating slurry and slurry viscosity. Alternatively, repeated immersions of the substrate in the coating slurry can be conducted, followed by removal of the excess slurry as described above. In a specific embodiment, the loading of the first layer upon the substrate is between about 0.2 to about 4.0 g/in³.

In an alternative embodiment which utilizes a wall flow substrate, the substrates are immersed vertically in a portion of the catalyst slurry such that the top of the substrate is located just above the surface of the slurry. The sample is left in the slurry for about 30 seconds. The substrate is removed from the slurry, and excess slurry is removed from the wall flow substrate first by allowing it to drain from the channels, then by blowing with compressed air against the direction of slurry penetration), and then by pulling a vacuum from the direction of slurry penetration. By using this technique, the catalyst slurry permeates the walls of the substrate, yet the pores are not occluded to the extent that undue back pressure will build up in the finished substrate. As used herein, the term “permeate” when used to describe the dispersion of the catalyst slurry on the substrate, means that the catalyst composition is dispersed throughout the wall of the substrate. Multiple coatings will typically yield a fraction of the catalyst within the porous walls and a remainder on the surface of the walls. After coating, the coated substrate is dried at about 100° C. and calcined by heating, e.g., at 300-650° C. for about 1 to about 3 hours. In some cases, the complete removal of the liquid and other volatile components may not occur until the catalyst is placed into use and subjected to the high temperatures encountered during operation.

### EXAMPLES

Aspects of the invention will be further described with reference to specific examples. These examples are merely representative of the myriad of embodiments possible which fall within the scope of the invention and should not be taken as limiting the invention.

### Example 1

### Sample Preparation

A sample of 1.5% SiO₂ doped into γ-alumina was impregnated to a level below its incipient wetness using a basic solution containing [Pt(OH)₆]²⁻. The concentration of the platinum-containing solution was controlled so as to give the desired Pt loading on the support. This powder was then impregnated with a solution of dilute acetic acid which results in precipitation and fixation of PtO₂.xH₂O onto the oxide surface. The powder was suspended in DI water and milled either in a ball mill or a continuous mill to a particle size about D₉₀<8 μm (90% of the particles with a diameter less than about 8 μm). To this suspension was added a solution of copper nitrate or copper acetate such as to give the target copper loading and the target solids content of approx 40%. The ceramic monolith was dipped into this suspension, and the excess slurry distributed and removed by blowing air through the channels. The wet monolith was dried at 100-130° C. and then calcined at 500-600° C. for one hour. Although the target was to obtain the entire catalyst loading in a single coating process, it typically required two coatings in order to achieve the target loading on the monolith.

### Example 2

### Sample Testing

Substrates used with these examples were 3.0 inch long, 400 square cells/in², 6 mil wall thickness, with a total of 144 cells. The test reaction conditions used a gas makeup of 500 ppm NH₃, 10% O₂ (as air), 5% H₂O, with the balance being N₂. The gas hourly space velocity (GHSV) was 100,000/hr. The catalyst materials were prepared as thin films coated onto flow-through honeycomb substrates with a bulk loading of 1.5 g catalyst/in³ monolith volume.

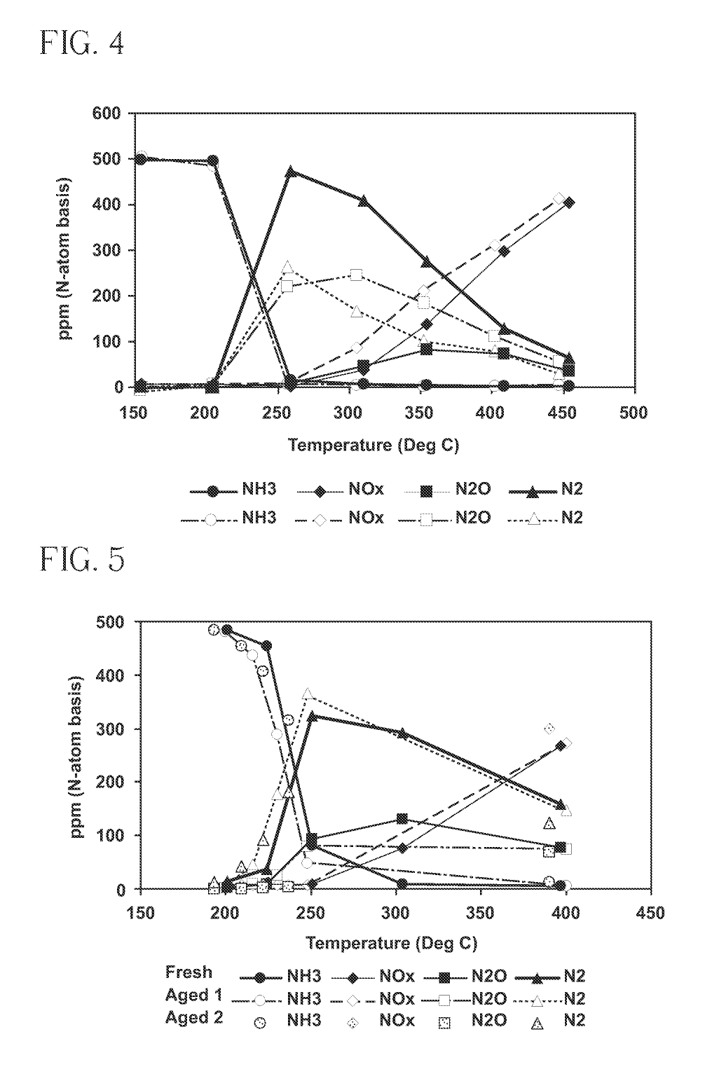

FIG. 4 shows an ammonia oxidation profile as a function of temperature for two catalysts having the same platinum loading but different copper oxide loadings. The data show that the catalyst activity is not negatively influenced by addition of copper oxide, and that N₂ selectivity can be improved by addition of copper oxide. The closed symbols are for 1.5% Pt+10% CuO immobilized on 1.5% SiO₂ doped into γ-alumina support. The open symbols are for 1.5% Pt immobilized on 1.5% SiO₂ doped into γ-alumina. As can be seen in FIG. 4, the N₂ product selectivity in the range between 200° C. to 350° C. is enhanced considerably by the addition of copper oxide. This is due almost entirely to the decrease in N₂O production in the copper-containing catalyst in this temperature range.

FIG. 5 shows an ammonia oxidation profile as a function of temperature for an embodiment of the catalyst that contains much lower Pt content than the previous example. The closed symbols are 0.2% Pt+2.5% CuO immobilized on 1.5% SiO₂ doped into γ-alumina support in the fresh state. The open symbols are the same catalyst after aging at 750° C. for 25 hr in a 10% H₂O/air environment. As shown in FIG. 5, there was no significant decrease in ammonia oxidation efficiency, and there was essentially no change seen between the fresh NH₃ activity of catalyst and the hydrothermally aged NH₃ activity of the catalyst. The diamonds are the same catalyst after aging at 800° C. for 25 hr in a 10% H₂O/air environment. FIG. 5 shows that activity can be maintained below 250° C. while decreasing the Pt content by a factor of 8× (which substantially decreases the cost of the catalyst), but the trade-off is that the selectivity enhancement from copper oxide is not as pronounced. These data also illustrate the stability of this catalyst against hydrothermal aging to as high as 800° C.

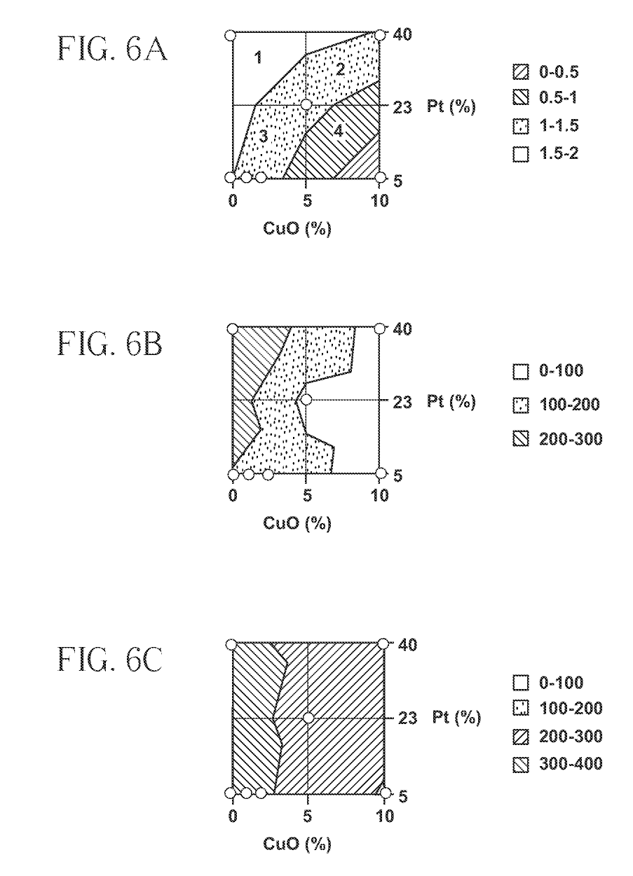

FIG. 6 shows an optimization matrix for the Pt+CuO on 1.5% SiO₂ doped into γ-alumina system. (A) shows the impact of Pt and copper composition on NH₃ conversion; (B) shows the N₂O production at 250° C.; and (C) shows the NOₓ production at 400° C. All data points were measured after aging at 700° C. for 10 hr in a 10% H₂O/air environment. The data shows that there is minimal benefit in going to higher Pt loading except at high CuO loading, where high Pt loading is required to maintain activity. The activity and selectivity are comparable in quadrants 2 and 3, but quadrant 3 has a lower Pt composition, resulting in a less expensive catalyst. Therefore, NOₓ production does not appear to be as strongly affected by copper oxide within this compositional space. However, further experimentation may be required to confirm this.

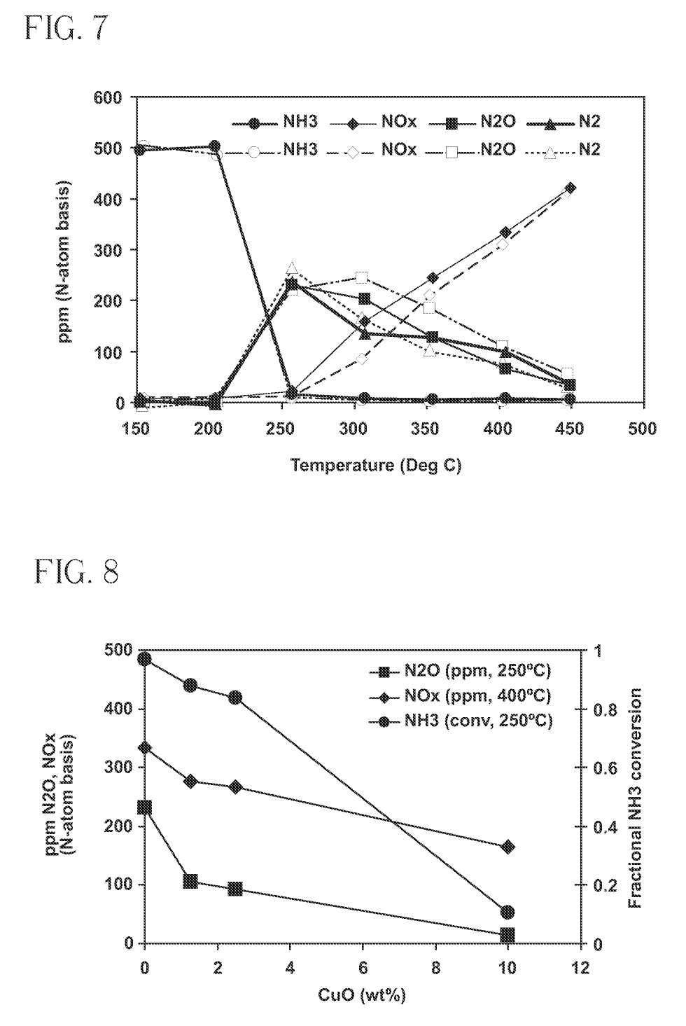

FIG. 7 shows an ammonia oxidation profile as a function of temperature for two catalysts having low and high platinum loadings. The data show that for Pt concentrations above 0.2%, Pt can be varied over nearly an order of magnitude without substantially changing the activity or selectivity. This is contrary to the inventors' current understanding of the literature, which teaches that bulk oxidation is improved by increasing Pt content. The closed symbols represent 0.2% Pt immobilized on Siralox1.5 support. The open symbols represent 1.6% Pt immobilized on Siralox1.5. As can be seen from FIG. 7, the optimal NH₃ conversion level can be achieved with the lowest levels of Pt studied, and N₂O selectivity can then be independently tuned by addition of copper oxide.

FIG. 8 shows the NH₃ conversion and N₂O/NOₓ emission as a function of copper oxide loading. for a catalyst having a Pt content of 0.2%. The data shows that CuO decreases N₂O and NOₓ emission, but at the penalty of also decreasing NH₃ conversion. The slope of the N₂O versus % CuO is high below 2.5 wt % copper oxide, but levels off at high % CuO. Hence most of the benefit of CuO in terms of selectivity is observed below 2.5%. At this level, we decrease N₂O by a factor of 2× relative to having no CuO, and we only decrease NH₃ conversion by 15%. Thus, the optimum catalyst in terms of the compromise between activity, selectivity, and cost has low Pt (approx 0.2%) and low CuO (1.5-3%).

### Example 3

### Sample Characterization

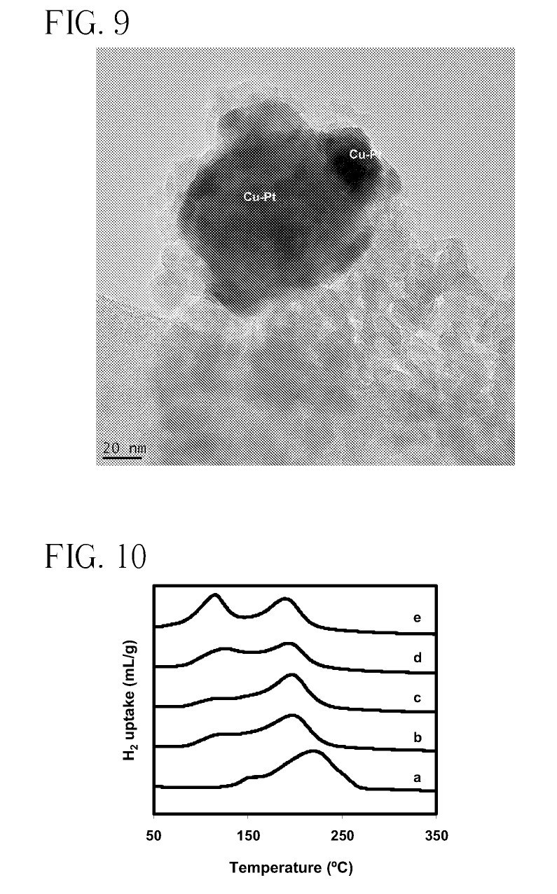

A sample containing 10 wt % copper and 1.6 wt % platinum was prepared as described in Example 1. A sample of the catalyst coating slurry was dried, calcined at 550° C., and aged at 700° C. for 10 hr in 10% H₂O/air. The powder sample was mounted on a carbon fiber net and a transmission electron micrograph image was collected at 200 keV, shown in FIG. 9. The dark area of the image represents a crystallite that contains both copper and platinum, as shown by associated energy dispersive spectroscopy (EDS) spot analysis. These data suggest a direct chemical interaction between Pt and Cu in the Pt+CuO on Al₂O₃ system. A direct interaction between Pt and Cu is supported by H₂ temperature-programmed reduction (TPR) data. Samples of dried slurry powder were treated in He at 400° C. for 30 min. Then the powder samples were exposed to a gas feed of 7% H₂/N₂ and the temperature ramped from room temperature to 800° C. at 10° C./min. The resulting thermal profiles are shown in FIG. 10. For 10% CuO on Siralox1.5, trace a in FIG. 10 shows a single bulk reduction peak at 220° C., with a small shoulder at 150° C. attributable to the preliminary adsorption of H₂ on surface CuO sites. There were no peaks observed above 350° C. up to about 850° C. The H₂ uptake corresponds to reduction by 0.94 (±0.05) electron per copper atom, indicating that the relevant reduction process leads to formation of primarily cuprous oxide, Cu₂O (i.e. reduction by one electron/Cu atom). Addition of 0.125% Pt to the sample decreased the peak reduction temperature by 23° C., shown in trace b, indicating that Pt catalyzes the reduction of CuO by hydrogen. As the Pt content of the sample is increased from 0.25% (trace c) to 0.50% (trace d) to 1.0% (trace e), a new TPR reduction peak appears at 115° C., although the total H₂ uptake still corresponds to one electron/Cu atom. The appearance of this new reduction peak is interpreted to result from reduction of Cu very closely associated with Pt. Without limiting the invention to a particular theory, it is suggested that TEM data combined with the TPR data strongly indicate formation of an oxide phase containing Pt and Cu, and that these sites lead to the high selectivity for N₂ production over N₂O production at 250° C.

In detailed aspects, the catalyst exhibits two peaks, or local maxima, in a hydrogen temperature programmed reduction experiment when the catalyst has been treated in He at about 400° C. for about 30 minutes and then exposed to a feed gas of about 7% H₂/N₂ and the temperature is ramped from room temperature to about 800° C. at about 10° C./min. In other detailed aspects, there are substantially no peaks observed at temperatures in the range of about 350° C. and about 800° C.

The first peak, or local maximum, of some aspects is observed at a temperature less than about 150° C. In other aspects, the first peak is observed at temperatures less than about 140° C. or about 130° C.

The second peak, or local maximum, of other aspects is observed at a temperature in the range of about 150° C. to about 250° C. In more detailed aspects, the second peak is observed in the range of about 175° C. and about 225° C. In further detailed aspects, the second peak is observed at temperatures greater than about 150° C., 175° C. or 200° C.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A method for treating emissions produced in the exhaust gas stream of a diesel or lean-burn vehicle, the method comprising:
passing a vehicle's engine exhaust stream through a NOx abatement catalyst; and
passing the exhaust stream exiting the NOx abatement catalyst and containing ammonia through an oxidation catalyst comprising a refractory metal oxide, a transition metal oxide and platinum, the oxidation catalyst being effective to oxidize ammonia at temperatures less than about 300° C. and exhibiting no significant decrease in ammonia oxidation efficiency upon hydrothermal aging.

2. The method of claim 1, wherein the NOx abatement catalyst comprises an SCR catalyst, an LNT catalyst, or other catalyst for the destruction of NOx that results in slippage of ammonia from the NOx abatement catalyst.

3. The method of claim 1, wherein the NOx abatement catalyst and oxidation catalyst composition are disposed as coatings on separate substrates.

4. The method of claim 3, wherein either the NOx abatement catalyst or the oxidation catalyst is disposed as a coating on a wall-flow filter.

5. The method of claim 1, wherein the NOx abatement catalyst and the oxidation catalyst are disposed as a coating on a substrate.

6. The method of claim 5, wherein the substrate comprises a wall flow filter and the NOx abatement catalyst and the oxidation catalyst are disposed on the same substrate.

7. The method of claim 1, wherein the refractory metal oxide support is selected from alumina, silica, zirconia, titania, ceria, and physical mixtures or chemical combinations thereof, including atomically doped combinations.

8. The method of claim 1, wherein the transition metal oxide comprises a CuₓO, or a chemical or physical mixture of CuₓO.

9. The method of claim 8, wherein platinum is present in an amount in the range of about 0.05% and 2.0% by weight of the catalyst and CuₓO is present in the range of about 0.5% and about 15% by weight of the catalyst.

10. The method of claim 8, wherein platinum is present in an amount in the range of about 0.05% and about 1.6% by weight ofthe catalyst and CuₓO is present in the range of about 0.5% and about 10% by weight of the catalyst

11. The method of claim 8, wherein platinum is present in an amount about 0.2% by weight and CuₓO is present in an amount about 2.5% by weight.

12. The method of claim 8, wherein the total oxidation catalyst is coated on a substrate in the range of about 0.2 g/in³ and about 4.0 g/in³.

13-21. (canceled)

22. The method of claim 1, wherein the oxidation catalyst exhibits two maxima in a hydrogen temperature programmed reduction experiment when the catalyst has been treated in He at about 400° C. for about 30 minutes and then exposed to a feed gas of about 7% H₂/N₂ and the temperature is ramped from room temperature to about 800° C. at about 10° C./min.

23. The method of claim 22, wherein no peaks are observed at temperatures greater than about 350° C. up to about 800° C.

24. The method of claim 22, wherein the first maximum is observed at a temperature less than about 150° C.

25. The method of claim 22, wherein the second maximum is observed at a temperature in the range of about 150° C. to about 250° C.

26. A treatment system for an exhaust stream containing NOx, the system comprising: an upstream catalyst composition effective for decreasing NOx; and a downstream oxidation catalyst composition effective for oxidizing ammonia, the oxidation catalyst comprising a refractory metal oxide, a transition metal oxide, and platinum, the platinum being present in the range of about 0.05% and 2.0% by weight of the catalyst and the transition metal oxide being present in the range of about 0.5% and 15 weight percent of the catalyst, the oxidation catalyst being effective to oxidize ammonia at temperatures less than about 300° C.

27. The system of claim 26, wherein the NOx abatement catalyst comprises an SCR catalyst, an LNT catalyst, or other catalyst for the destruction of NOx that results in slippage of ammonia from the NOx abatement catalyst.

28. The engine treatment system of claim 26, wherein the NOx abatement catalyst and oxidation catalyst composition are disposed on separate substrates.

29. The engine treatment system of claim 28, wherein either the NOx abatement catalyst or the oxidation catalyst is disposed on a wall-flow filter.

30. The engine treatment system of claim 26, wherein the NOx abatement catalyst and the oxidation catalyst are disposed as a washcoat on a substrate.

31. The engine treatment system of claim 30, wherein the NOx abatement catalyst and the oxidation catalyst are disposed on the same substrate which comprises a wall flow filter.

32. The engine treatment system of claim 26, further comprising a metering system for metering ammonia or an ammonia precursor at periodic intervals into the exhaust stream.

33. The system of claim 26, wherein the oxidation catalyst exhibits two maxima in a hydrogen temperature programmed reduction experiment when the catalyst has been treated in He at about 400° C. for about 30 minutes and then exposed to a feed gas of about 7% H₂/N₂ and the temperature is ramped from room temperature to about 800° C. at about 10° C./min.

34. The system of claim 33, wherein no peaks are observed at temperatures greater than about 350° C. up to about 800° C.

35. The system of claim 33, wherein the first maximum is observed at a temperature less than about 150° C.

36. The system of claim 33, wherein the second maximum is observed at a temperature in the range of about 150° C. to about 250° C.
